(19) United States
(12) Patent Application Publication
(10) Pub. No.: US 2010/0227564 A1
(43) Pub. Date: Sep. 9, 2010

(54) COMMUNICATION MODULE AND COMMUNICATION METHOD

(76) Inventor: Shigemitsu Kaneko, Fukushima-Ken (JP)

Correspondence Address: BRINKS HOFER GILSON & LIONE, P.O. BOX 10395, CHICAGO, IL, 60610, US

(21) Appl. No.: 12/716,892

(22) Filed: Mar. 3, 2010

(30) Foreign Application Priority Data
Mar. 4, 2009 (JP) 2009-050219

(51) Int. Cl. H04B 7/00

(52) U.S. Cl. 455/66.1

(57) ABSTRACT

A communication module mounted on a local device wirelessly communicating with a remote device having a wireless communication function on the basis of a predetermined communication protocol, includes a wireless communication section configured to wirelessly communicate with the remote device on the basis of the predetermined communication protocol, a storage section configured to store a plurality of parameters defined by the predetermined communication protocol, and a connection processing section configured to issue a connection request to the remote device using a parameter reported from the remote device as a result of inquiring of the remote device about a corresponding parameter when a connection to the remote device is made.

### CROSS REFERENCE TO RELATED APPLICATIONS

The present invention contains subject matter related to and claims priority to Japanese Patent Application JP 2009-050219 filed in the Japanese Patent Office on Mar. 4, 2009, the entire contents of which being incorporated herein by reference.

### BACKGROUND

1. Technical Field

The present disclosure relates to a communication module and a communication method for performing, for example, wireless communication between a plurality of devices.

2. Related Art

In terms of the transmission of data having a plurality of formats (for example, JPEG and TIFF for an image or MP3 and WMA for an audio) such as image data or audio data, in the related art, data is converted by automatically selecting a recommendation format suitable for a destination designated by a user and transmitting the converted data to the destination (see Japanese Unexamined Patent Application Publication No. 2005-227911).

In the above-described related art, information regarding a destination table, a conversion rule table, or the like is stored in advance in a device possessed by a user of a portable phone or the like. When the user designates an arbitrary destination from a list of a plurality of destinations recorded in the destination table, a recommendation format corresponding thereto is read from the conversion rule table and a conversion program automatically converts a data format. In the above-described related art, a size or a compression ratio as well as a format for image data or a sampling rate (audio quality) for audio data may be automatically adjusted.

Thus, according to the above-described related art, it is not necessary to adjust in advance an image size or a compression ratio as required to comply with a format of a destination, for example, when the user captures an image using a digital camera or the like, and it is possible to transmit an image captured in a stand-alone state to an arbitrary destination later.

A method of the above-described related art is effective when all destination devices are known and a recommendation format for each destination is predefined. Recently, there is a growing need for freely establishing a connection between various unknown devices as well as known devices. When responding to this need, errors may occur at the time of starting a connection in the method of the related art.

For example, it is possible to implement wireless communication by mutually applying a generalized short-range communication protocol (for example, Bluetooth (registered trademark)) when a wireless connection between unknown devices is performed (wherein “unknown device” means a device in which various parameters are used for communication and are uniquely unspecified and a terminal authentication procedure or the like is performed therefor). However, there is no guarantee that all parameters will correspond to both the unknown devices even when there is a plurality of available parameters for the communication protocol. Thus, in the case where a parameter from one device is uniquely designated at the time of a wireless connection, it is difficult to establish the connection when the other device does not support the parameter. As described above, there is a problem in that effort is necessary to establish a connection since only the designation of a unique parameter from one device is insufficient and the matching of both sides is necessary for a connection between unknown devices.

### SUMMARY

According to an embodiment of the present disclosure, a communication module, which is mounted on a local device wirelessly communicating with a remote device having a wireless communication function on the basis of a predetermined communication protocol, includes a wireless communication section configured to wirelessly communicate with the remote device on the basis of the predetermined communication protocol; a storage section configured to store a plurality of parameters defined by the predetermined communication protocol; and a connection processing section configured to issue a connection request to the remote device using a parameter reported from the remote device as a result of inquiring of the remote device about a corresponding parameter when a connection to the remote device is made.

In the communication module according to the embodiment of the present invention, it is possible to issue a connection request from the local device using a parameter reported from the remote device by asking in advance the remote device serving as a connection destination about supported parameters without having to unilaterally issue the connection request to the remote device by designating a unique parameter from the local device. Thus, it is possible to easily establish a wireless connection to any unknown remote device (which may use an arbitrary parameter and may not correspond to a unique parameter) when viewed from the local device, and thereafter it is possible to smoothly perform wireless communication.

Since a connection sequence, which is performed by designating a parameter which is not supported by the remote device, is not executed, it is possible to eliminate connection failure due to parameter mismatching and thereafter the effort of a resetting process or the like.

According to another embodiment, a communication method for performing wireless communication based on a predetermined communication protocol between a remote device and a local device having a wireless communication function includes the following steps.

### (1) Designating Step

In this step, a plurality of parameters defined by the predetermined communication protocol is designated.

### (2) Inquiring Step

In this step, an inquiry about a corresponding parameter is made from the local device to the remote device when a connection to the local device is made.

### (3) Receiving Step

In this step, the local device receives a response from the remote device as a notification. Accordingly, it is possible for the local device to determine which parameter corresponds to (or is supported by) the remote device.

### (4) Issuing Step

In this step, a connection request is issued to the remote device using a parameter reported from the remote device.

By executing the above-described (1) to (4) steps, it is possible to issue a connection request from the local device using a parameter reported from the remote device by asking in advance the remote device serving as a connection destination about supported parameters without having to unilaterally issue the connection request to the remote device by designating a unique parameter from the local device. Thus, it is possible to easily establish a wireless connection to any unknown remote device (which may use an arbitrary parameter and may not correspond to a unique parameter) when viewed from the local device, and thereafter it is possible to smoothly perform wireless communication.

Since a connection sequence, which is performed by designating a parameter which is not supported by the remote device, is not executed, it is possible to eliminate connection failure due to parameter mismatching and thereafter the effort of a resetting process or the like.

### BRIEF DESCRIPTION OF THE DRAWINGS

FIG. 1 is a diagram schematically showing a configuration example of a communication system to which a communication module (BT module) of an embodiment is applied.

FIG. 2 is a block diagram schematically showing a hardware configuration example of the BT module.

FIG. 3 is a sequence diagram showing a flow until a wireless connection by AVDTP is established between a local device and a remote device.

FIG. 4 is a flowchart specifically showing a procedure example of a parameter setting routine to be executed during a connection sequence.

FIG. 5 is a flowchart showing a procedure example of an SBC sampling frequency setting process.

FIG. 6 is a flowchart showing a procedure example of an SBC channel mode setting process.

FIG. 7 is a flowchart showing a procedure example of an SBC block length setting process.

FIG. 8 is a flowchart showing a procedure example of an SBC subband setting process.

FIG. 9 is a flowchart showing a procedure example of an SBC allocation method setting process.

FIG. 10 is a flowchart (1/2) showing a procedure example of a process of setting an SBC minimum bit pool value and an SBC maximum bit pool value.

FIG. 11 is a flowchart (2/2) showing a procedure example of the process of setting an SBC minimum bit pool value and an SBC maximum bit pool value.

FIG. 12 is a flowchart showing a procedure example of an SCMS capability setting process.

FIG. 13 is a flowchart showing the content of a disconnection process.

### DESCRIPTION OF EXEMPLARY EMBODIMENTS

Hereinafter, embodiments of the present invention will be described with reference to the drawings.

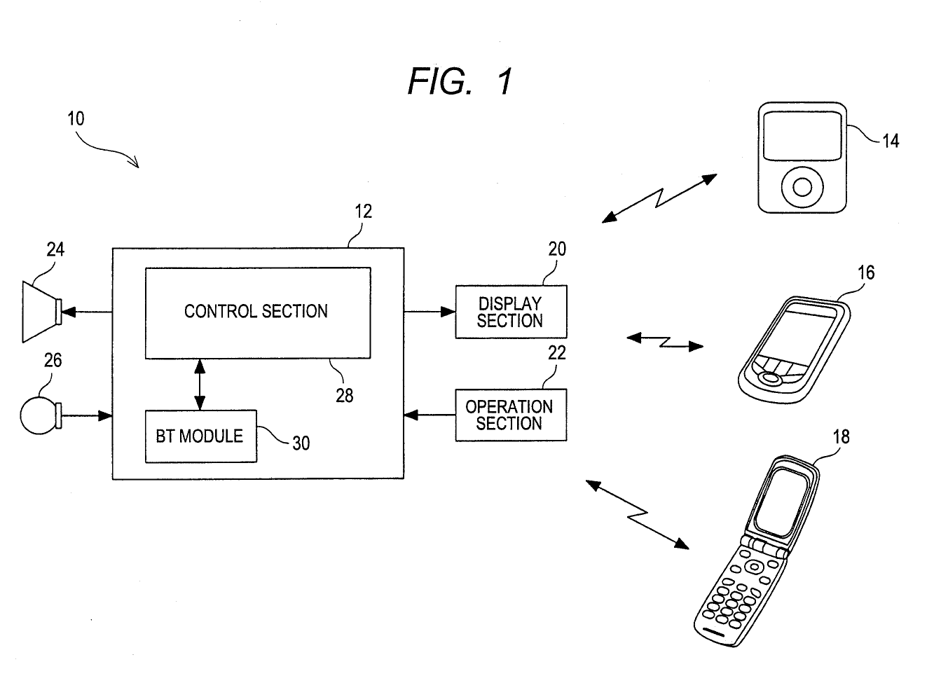

FIG. 1 is a diagram schematically showing a configuration example of a communication system 10 to which a communication module (BT module 30) of the embodiment is applied. For example, the communication system 10 includes an in-vehicle electrical equipment unit 12 mounted in a car as a local device and various portable devices 14, 16, and 18 introduced into the car as remote devices. The in-vehicle electrical equipment unit 12 and the portable devices 14, 16, and 18 all have a wireless communication function based on a Bluetooth (registered trademark) protocol. In the following description, Bluetooth (registered trademark) is abbreviated as “BT”.

For example, the in-vehicle electrical equipment unit 12 has an audio playback function, a video playback function, or a radio or television reception function as well as a driving route guidance (navigation) function. Thus, peripheral devices such as acoustic output speaker 24 and a microphone 26 as well as a display section 20 using a liquid crystal display or the like or an operation section 22 having a push button, a key switch, or a rotary knob (all of which are not shown) are attached to the in-vehicle electrical equipment unit 12.

The BT module 30 having a wireless communication function by BT as well as a control section 28 which controls the peripheral devices is embedded in the in-vehicle electrical equipment unit 12. For example, the control section 28 is a microcomputer having a CPU as a central processing unit and/or a memory device such as a ROM or a RAM. The BT module 30 can provide a service (for example, a wireless connection) using BT communication by employing the in-vehicle electrical equipment unit 12 (the control section 28) as a host.

For example, the portable devices 14, 16, and 18 are electronic devices capable of being carried and used by a user such as a portable music player, a portable information terminal, a mobile phone, or the like. For any of these, a BT module (not shown) is also embedded in the portable devices 14, 16, and 18, and the portable devices 14, 16, and 18 can respectively have a wireless communication function by BT using the BT module.

### Type of Usage of Wireless Connection

For example, the communication system 10 can provide a function of reproducing audio data in real time and outputting the music from the speaker 24 while transmitting the audio data stored in the portable device 14 to the in-vehicle electrical equipment unit 12 in a state in which the in-vehicle electrical equipment unit 12 is wirelessly connected to the music player portable device 14.

The communication system 10 can provide a function of transmitting address book data stored in the portable device 16 to the in-vehicle electrical equipment unit 12 and outputting the address book data to the display section 20 in a state in which the in-vehicle electrical equipment unit 12 is wirelessly connected to the portable device 16 as the portable information terminal. Alternatively, the communication system 10 can provide a so-called “hands-free call” function in a state in which the in-vehicle electrical equipment unit 12 is wirelessly connected (BT-linked) to the portable device 18.

It is necessary to surely establish a wireless connection between the in-vehicle electrical equipment unit 12 and various portable devices 14, 16, and 18 as a priori assumption to implement the functions as described above in the communication system 10. In this case, the communication system 10 includes various portable devices 14, 16, and 18 serving as communication objects (connection destinations) to the single in-vehicle electrical equipment unit 12. Specifically, when the in-vehicle electrical equipment unit 12 is set as a local device fixed to some extent, the portable devices 14, 16, and 18 introduced into the car by the user are of great variety. There is no guarantee that the portable devices 14, 16, and 18 will correspond to a unique parameter. When viewed from the local device, the portable devices 14, 16, and 18 become unknown remote devices (BT terminal authentication is assumed to be performed).

On the other hand, a plurality of parameters is used when a wireless connection between a plurality of devices is established for BT communication. Thus, the wireless connection between two devices is not established when the portable devices 14, 16, and 18 do not support a parameter even though the in-vehicle electrical equipment unit 12 (local device) designates a unique parameter.

In this embodiment, the BT module 30 of the in-vehicle electrical equipment unit 12 (local device) has the following configuration to implement a wireless connection with various portable devices 14, 16, and 18 (unknown remote devices).

### Configuration Example of BT Module

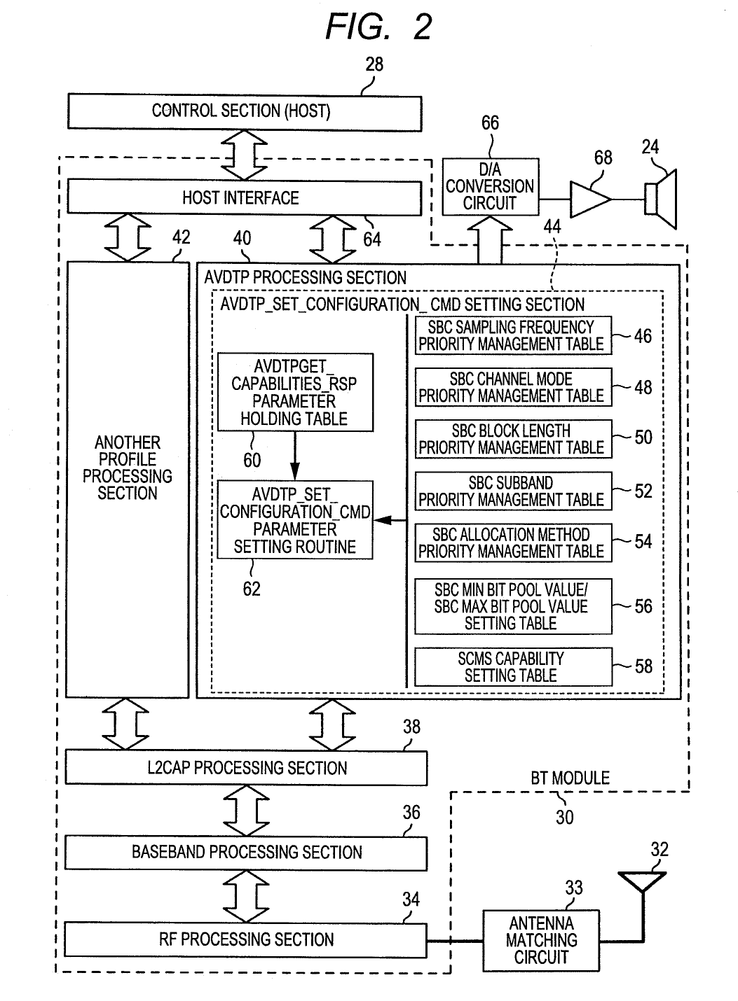

FIG. 2 is a block diagram schematically showing a hardware configuration example of the BT module 30. For example, the BT module 30 is connected to a BT antenna 32 and an antenna matching circuit 33 within the in-vehicle electrical equipment unit 12 and is capable of performing wireless communication by the BT protocol with other BT devices (here, the portable devices 14 to 18) using the BT antenna 32 and the antenna matching circuit 33 (a wireless communication section). The BT antenna 32 or the antenna matching circuit 33 may be embedded in the BT module 30.

The BT module 30 has an RF processing section 34, a baseband processing section 36, and an L2CAP processing section 38. The RF processing section 34 receives and processes an RF signal through the BT antenna 32 and the antenna matching circuit 33. The baseband processing section 36 converts the signal received by the RF processing section 34 into an IF signal, demodulates the IF signal, and generates packet data (a received packet). The L2CAP processing section 38 reconfigures the packet data generated by the baseband processing section 36 for a higher layer. Here, the reconfigured packet data is provided to a higher-layer processing section within the BT module 30.

Transmission packet data (a transmission frame) is provided from a higher layer to the L2CAP processing section 38. The transmission packet data provided to the L2CAP processing section 38 is modulated by the baseband processing section 36, and is transmitted to the portable devices 14 to 18 through the RF processing section 34, the antenna matching circuit 33, and the BT antenna 32.

The BT module 30 has an AVDTP processing section 40 and another profile processing section 42. The processing sections 40 and 42 are located on a higher layer of the L2CAP processing section 38. The AVDTP processing section 40 executes a connection sequence and a communication process using Audio/Video Distribution Transport Protocol (hereinafter, abbreviated as “AVDTP”) in BT communication. The other profile processing section 42 executes a connection sequence and a communication process using a communication profile (for example, a serial port profile) other than the AVDTP in the BT communication.

### Connection Processing Section

Further, the AVDTP processing section 40 includes a command setting section 44. The command setting section 44 issues a connection request command (described by AVDTP_SET_CONFIGURATION_CMD in the figure) to the portable devices 14, 16, and 18 as the remote devices when executing a connection sequence by the AVDTP.

### Storage Section

Further, the command setting section 44 includes a plurality of parameter priority management tables 46, 48, 50, 52, and 54 and parameter setting tables 56 and 58. Various parameters for setting the above-described connection request command are stored in various tables 46 to 58.

### Parameters

Here, in this embodiment, for example, the following parameters are applied as parameters to be used by the AVDTP. Hereinafter, “SBC” is the abbreviation for Sub Band Codec used in BT communication. Each parameter includes a plurality of values within parentheses as examples.
(1) SBC sampling frequency (48 kHz and 44.1 kHz)
(2) SBC channel mode (MONO, DUALCHANNEL, STEREO, and JOINTSTEREO)
(3) SBC block length (4, 8, 12, and 16)
(4) SBC subbands (4 and 8)
(5) SBC allocation method (SNR and Loudness)
(6) SBC minimum bit pool value (an arbitrary integer from 2 to 53)
(7) SBC maximum bit pool value (an arbitrary integer from 2 to 53)
(8) SCMS capability (“Not support SCMS” and “Support SCMS”)

In terms of (1) SBC sampling frequency to (5) SBC allocation method among the above-described parameters, the parameters are stored in a state in which priorities are associated with a plurality of values in each of the priority management tables 46 to 54. For example, in terms of (1) SBC sampling frequency, “44.1 kHz” is set to a first priority and “48 kHz” is set to a second priority (the opposite is also possible). For example, in terms of (2) SBC channel mode, “JOINTSTEREO” is set to a first priority, “STEREO” is set to a second priority, “DUALCHANNEL” is set to a third priority, and “MONO” is set to a fourth priority (others are also possible).

In terms of (6) SBC minimum bit pool value and (7) SBC maximum bit pool value, values are stored in one setting table 56. In terms of (8) SCMS capability, values are stored in another setting table 58.

The command setting section 44 includes a parameter holding table 60 as well as various tables 46 to 58. Parameter values reported from the portable devices 14, 16, and 18 as the remote devices are held in the parameter holding table 60. A notification transmitted from the remote device (described by “AVDTP_GET_CAPABILITIES_RSP” in the figure) will be further described later.

A parameter setting routine 62 is stored as a program in the command setting section 44. The command setting section 44 can set the connection request command “AVDTP_SET_CONFIGURATION_CMD” issued from the AVDTP processing section 40 by executing the parameter setting routine 62. Details of the parameter setting routine 62 will be described later with reference to a specific flowchart.

The BT module 30 also has a host interface 64. When the control section 28 provided in the above-described in-vehicle unit 12 is set as a host, the host interface 64 controls communication between the host and the BT module 30.

For example, when the user has executed an operation regarding the BT communication through the operation section 22 of the in-vehicle unit 12, an operation signal is transmitted from the control section 28 of the host side to the host interface 64. The host interface 64 receiving the operation signal controls an operation of the AVDTP processing section 40 or the other profile processing section 42. The host interface 64 outputs packet data received by the AVDTP processing section 40 or the other profile processing section 42 to the control section 28 of the host side. A D/A conversion circuit 66 within the in-vehicle electrical equipment unit 12 converts acoustic data (audio data or voice call data) processed by the AVDTP processing section 40 into an analog signal (voltage) and outputs the analog signal to the speaker 24 through an amplifier 68 of a subsequent stage.

Thus, for example, audio data or voice call data received by BT communication from the portable device 18 can be output from the speaker 24 of the in-vehicle unit 12, or conversely sounds picked up by the microphone 26 can be transmitted to the portable device 18.

### BT Communication Method

Next, an example of a communication method to be executed in the communication system 10 of this embodiment will be described.

### Connection Sequence

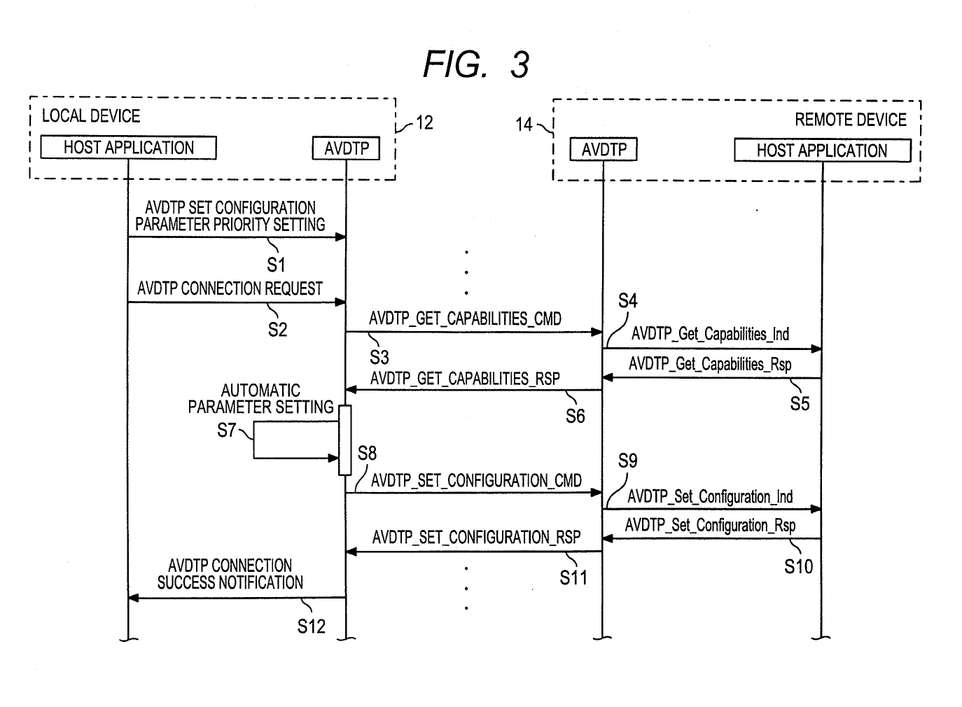

FIG. 3 is a sequence diagram showing a flow until a wireless connection by AVDTP is established between a local device and a remote device. In FIG. 3, a process by the local device (the in-vehicle unit 12) is shown on two columns located at the left and a process by the remote device (for example, the portable device 14) is shown on two columns located at the right. In the following description, the in-vehicle unit 12 and the portable device 14 are generalized and respectively referred to as the local device and the remote device.

### Designation Process

S1: With the start of a connection sequence, priorities of various parameters from a host application of the local device to the BT module 30 are designated (as described by “AVDTP_SET_CONFIGURATION” in the figure). Although not particularly shown, the AVDTP processing section 40 of the BT module 30 receiving the above-described designation stores the priorities designated for various parameters in the corresponding priority management tables 46 to 54.

S2: Subsequently, an AVDTP connection request is directed from the host application to the BT module 30 on the basis of a BT communication protocol.

### Inquiry Process

S3: The BT module 30 receives the AVDTP connection request and transmits an inquiry command to the remote device (as described by “AVDTP_GET_CAPABILITIES_CMD” in the figure). This command is used to inquire about a parameter actually corresponding to (or supported by) the remote device and request a response thereof.

S4: Upon receipt of the above-described request, for example, the request is transferred from the AVDTP processing section to the host application as a process within the remote device (as described by “AVDTP_Get_Capabilities_Ind” in the figure).

S5: A host application within the remote device notifies the AVDTP processing section of its own corresponding parameter in response to the request (as described by “AVDTP_Get_Capabilities_Rsp” in the figure).

### Reception Process

S6: The remote device notifies the local device of its own corresponding parameter on the basis of the BT communication protocol (as described by “AVDTP_GET_CAPABILITIES_RSP” in the figure).

At this time, when the local device receives a notification from the remote device although not particularly shown, its value is stored in the parameter holding table 60. When the number of parameters reported from the local device is equal to or greater than 2, all parameters are stored in the holding table 60.

### Issuance Process

S7: Upon receipt of the notification, first, the local device automatically sets a parameter. Here, a priority (“AVDTP_SET_CONFIGURATION”) designated (set) by the host application is compared with the notification value (“AVDTP_GET_CAPABILITIES_RSP”) received from the remote device. A parameter of a connection request command “AVDTP_SET_CONFIGURATION_CMD” for the next remote device is automatically set. At this time, the above-described parameter setting routine 62 in the local device (command setting section 44) is called, and a process is executed along its procedure. A specific procedure of the process will be described later using a separate flowchart.

S8: When the parameter is automatically set as described above, a connection request is actually issued from the local device to the remote device.

S9: For example, a connection request (as described by “AVDTP_Set_Configuration_Ind” in the figure) is transferred from the AVDTP processing section to the host application as a process within the remote device when the remote device receives a connection request command.

S10: Next, the host application within the remote device notifies the AVDTP processing section of a response to the connect request (as described by “AVDTP_Set_Configuration_Rsp” in the figure).

S11: The remote device notifies the local device of the response to the connection request on the BT communication protocol (as described by “AVDTP_SET_CONFIGURATION_RSP” in the figure). At this time, the local device receives a response notification from the remote device.

S12: Upon receipt of the response notification from the remote device, a successful AVDTP connection is reported from the BT module 30 within the local device to the host application. Thereafter, wireless communication by AVDTP is performed between the local device and the remote device.

### Parameter Setting Routine

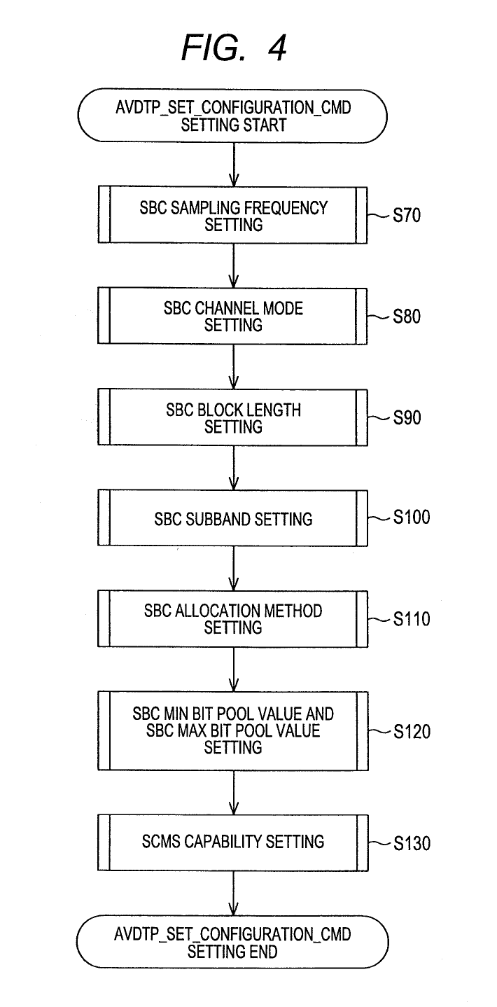

FIG. 4 is a flowchart specifically showing a procedure example of a parameter setting routine executed in the above-described connection sequence (S7). First, an outline for the configuration of the parameter setting routine will be described.

The command setting process is constituted to include a sub-routine group of an SBC sampling frequency setting process (step S70), an SBC channel mode setting process (step S80), an SBC block length setting process (step S90), an SBC subband setting process (step S100), an SBC allocation method setting process (step S110), a process of setting an SBC minimum bit pool value and an SBC maximum bit pool value (step S120), and an SCMS capability setting process (step S130). The command setting section 44 can automatically set a parameter of a connection request command by sequentially executing the sub-routine group. Hereinafter, each sub-routine will be specifically described.

### SBC Sampling Frequency Setting Process

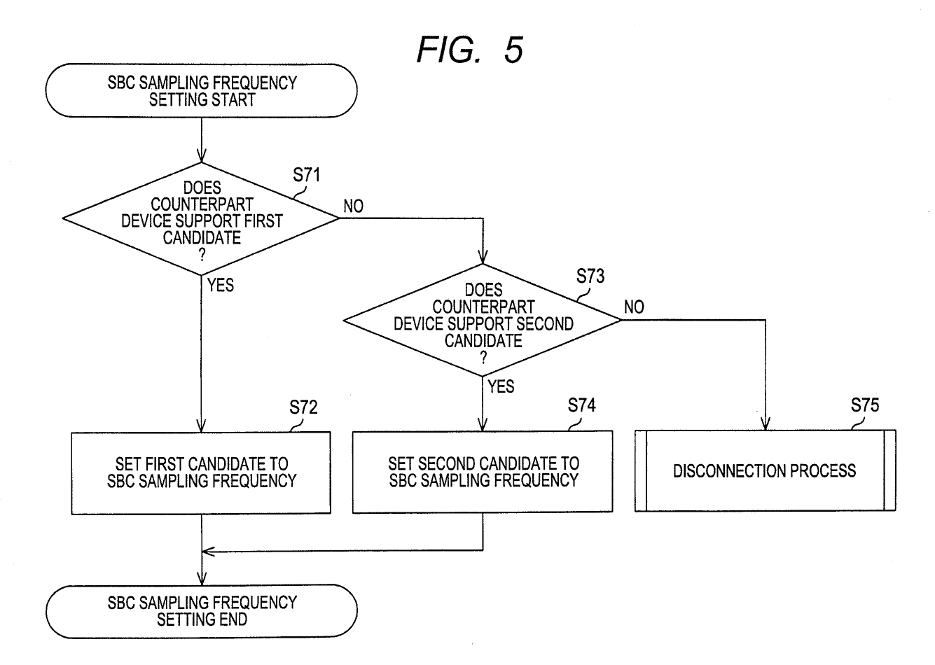

FIG. 5 is a flowchart showing a procedure example of the above-described SBC sampling frequency setting process. Hereinafter, an operation will be described in which the command setting section 44 of the BT module 30 serves as the subject to execute the process.

Step S71: Here, first, the command setting section 44 compares a parameter of a first candidate (a first priority) stored in the priority management table 46 with a value held in the parameter holding table 60 (a parameter reported from the remote device). As a result, when it has been determined that the remote device (indicated as the “counterpart device” in the figure) corresponds to the parameter of the first candidate (Yes), it proceeds to step S72. When at least two parameters reported from the remote device are stored, it is desirable that one parameter of the at least two parameters should match the first candidate.

Step S72: In this case, the command setting section 44 sets the parameter of the first candidate (for example, “44.1 kHz”) to the SBC sampling frequency and terminates this sub-routine (return).

On the other hand, when the remote device does not correspond to the parameter of the first candidate in the previous step S71 (No), the command setting section 44 executes step S73.

Step S73: Now, the command setting section 44 compares a parameter of a second candidate (a second priority) with a value held in the parameter holding table 60. As a result, when it has been determined that the remote device corresponds to the parameter of the second candidate (Yes), the command setting section 44 proceeds to step S74. Here, when at least two parameters reported from the remote device are stored, it is desirable that one parameter of the at least two parameters should match the second candidate.

Step S74: In this case, the command setting section 44 sets the parameter of the second candidate (for example, “48 kHz”) to the SBC sampling frequency and terminates this sub-routine (return).

On the other hand, when the remote device does not also correspond to the parameter of the second candidate (No), the command setting section 44 proceeds to a disconnection process of step S75. The disconnection process will be described together at the end.

### SBC Channel Mode Setting Process

Next, an SBC channel mode setting process will be described.

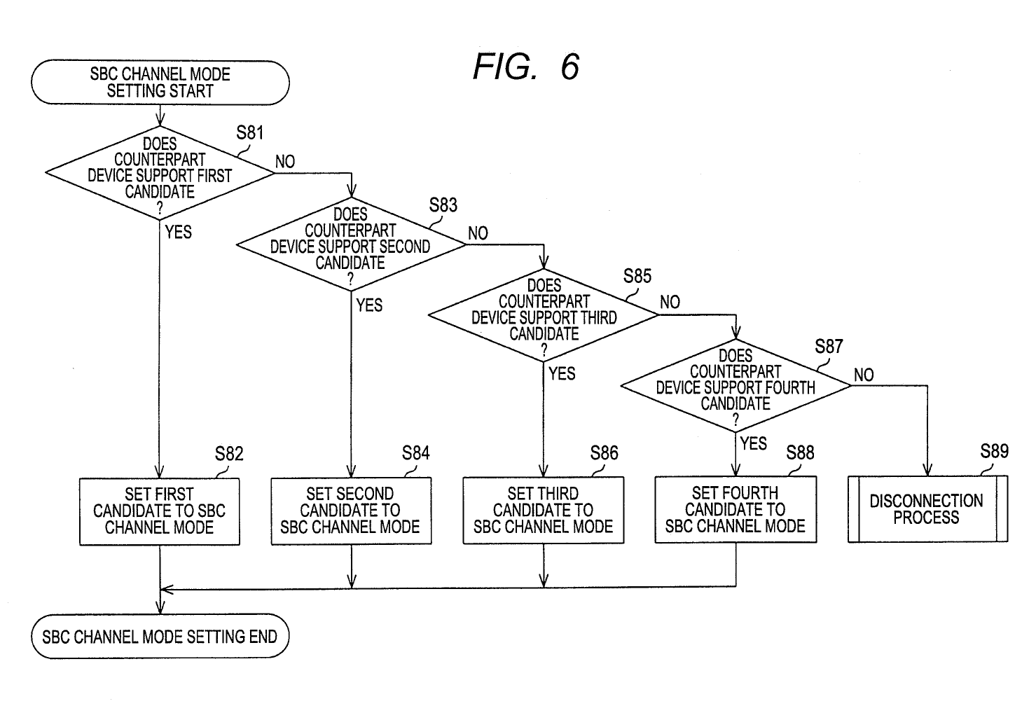

FIG. 6 is a flowchart showing a procedure example of the above-described SBC channel mode setting process. Hereinafter, the procedure example will be described.

Step S81: First, the command setting section 44 compares a parameter of a first candidate (a first priority) stored in the SBC channel mode priority management table 48 with a value held in the parameter holding table 60 (a parameter reported from the remote device). As a result, when it has been determined that the remote device corresponds to the parameter of the first candidate (Yes), the command setting section 44 proceeds to step S82. Likewise, when at least two parameters reported from the remote device are stored, it is desirable that one parameter of the at least two parameters should match the first candidate.

Step S82: In this case, the command setting section 44 sets the parameter of the first candidate (for example, “JOINTSTEREO”) to the SBC channel mode and terminates this sub-routine (return).

On the other hand, when the remote device does not correspond to the parameter of the first candidate in the previous step S81 (No), the command setting section 44 executes step S83.

Step S83: Now, the command setting section 44 compares a parameter of a second candidate (a second priority) with a value held in the parameter holding table 60. As a result, when it has been determined that the remote device corresponds to the parameter of the second candidate (Yes), the command setting section 44 proceeds to step S84. Here, when at least two parameters reported from the remote device are stored, it is desirable that one parameter of the at least two parameters should match the second candidate.

Step S84: In this case, the command setting section 44 sets the parameter of the second candidate (for example, “STEREO”) to the SBC channel mode and terminates this sub-routine (return).

When the remote device does not also correspond to the parameter of the second candidate in the previous step S83 (No), the command setting section 44 next executes step S85.

Step S85: Now, the command setting section 44 compares a parameter of a third candidate (a third priority) with a value held in the parameter holding table 60. As a result, when it has been determined that the parameter of the third candidate corresponds to the remote device (Yes), the command setting section 44 proceeds to step S86. Here, when at least two parameters reported from the remote device are stored, it is desirable that one parameter of the at least two parameters should match the third candidate.

Step S86: In this case, the command setting section 44 sets the parameter of the third candidate (for example, “DUALCHANNEL”) to the SBC channel mode and terminates this sub-routine (return).

Furthermore, when the remote device does not also correspond to the parameter of the third candidate in step S85 (No), the command setting section 44 next executes step S87.

Step S87: Next, the command setting section 44 compares a parameter of a fourth candidate (a fourth priority) with a value held in the parameter holding table 60. As a result, when it has been determined that the remote device corresponds to the parameter of the fourth candidate (Yes), the command setting section 44 proceeds to step S88. When at least two parameters reported from the remote device are stored, it is desirable that one parameter of the at least two parameters should match the fourth candidate as before.

Step S88: In this case, the command setting section 44 sets the parameter of the fourth candidate (for example, “MONO”) to the SBC channel mode and terminates this sub-routine (return).

On the other hand, when the remote device does not also correspond to the parameter of the fourth candidate (No), the command setting section 44 proceeds to a disconnection process of step S89.

### SBC Block Length Setting Process

Next, the SBC block length setting process will be described.

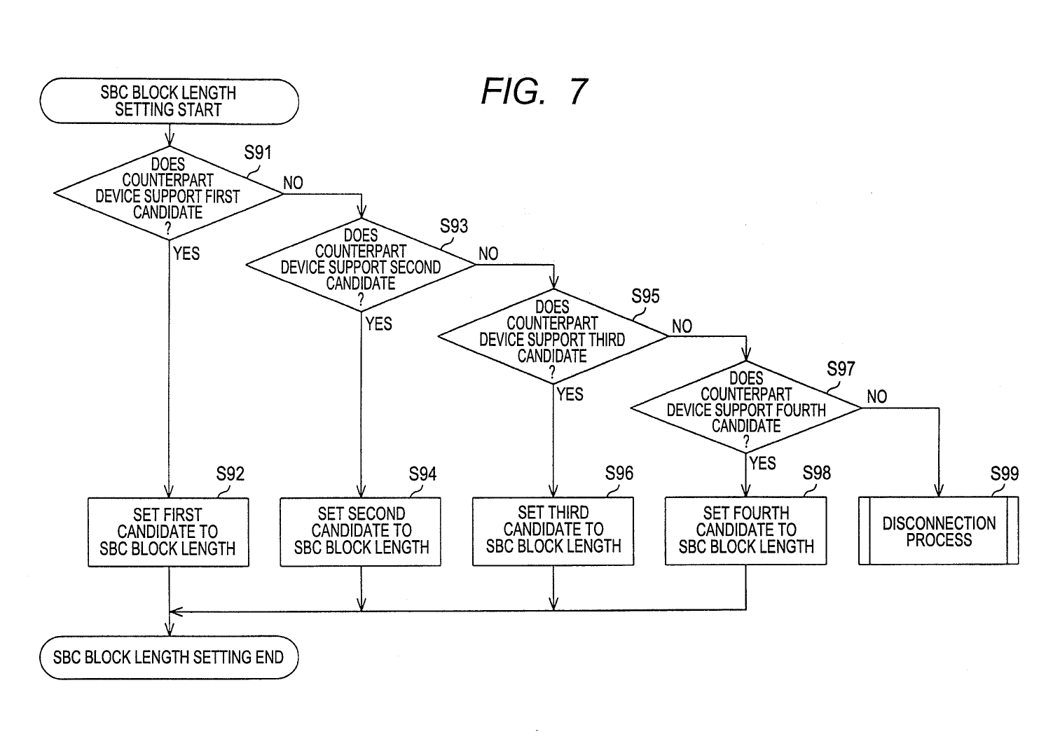

FIG. 7 is a flowchart showing a procedure example of the above-described SBC block length setting process. The difference between FIG. 6 and FIG. 7 is only that the parameter is changed from “SBC channel mode” to “SBC block length”.

Step S91: Likewise, the command setting section 44 compares a parameter of a first candidate (a first priority) stored in the SBC block length priority management table 50 with a value held in the parameter holding table 60 (a parameter reported from the remote device). As a result, when it has been determined that the remote device corresponds to the parameter of the first candidate (Yes), the command setting section 44 proceeds to step S92. Here, when at least two parameters reported from the remote device are stored, it is desirable that one parameter of the at least two parameters should match the first candidate as before (hereinafter, description thereof is omitted).

Step S92: In this case, the command setting section 44 sets the parameter of the first candidate (for example, “4”) to the SBC block length and terminates this sub-routine (return).

On the other hand, when the remote device does not also correspond to the parameter of the first candidate in the previous step S91 (No), the command setting section 44 executes step S93.

Step S93: Now, the command setting section 44 compares a parameter of a second candidate (a second priority) with a value held in the parameter holding table 60. As a result, when it has been determined that the remote device corresponds to the parameter of the second candidate (Yes), the command setting section 44 proceeds to step S94.

Step S94: In this case, the command setting section 44 sets the parameter of the second candidate (for example, “8”) to the SBC block length and terminates this sub-routine (return).

When the remote device does not also correspond to the parameter of the second candidate in the previous step S93 (No), the command setting section 44 next executes step S95.

Step S95: Now, the command setting section 44 compares a parameter of a third candidate (a third priority) with a value held in the parameter holding table 60. As a result, when it has been determined that the remote device corresponds to the parameter of the third candidate (Yes), the command setting section 44 proceeds to step S96.

Step S96: In this case, the command setting section 44 sets the parameter of the third candidate (for example, “12”) to the SBC block length and terminates this sub-routine (return).

Furthermore, when the remote device does not also correspond to the parameter of the third candidate in step S95 (No), the command setting section 44 next executes step S97.

Step S97: Next, the command setting section 44 compares a parameter of a fourth candidate (a fourth priority) with a value held in the parameter holding table 60. As a result, when it has been determined that the remote device corresponds to the parameter of the fourth candidate (Yes), the command setting section 44 proceeds to step S98.

Step S98: In this case, the command setting section 44 sets the parameter of the fourth candidate (for example, “16”) to the SBC block length and terminates this sub-routine (return).

On the other hand, when the remote device does not also correspond to the parameter of the fourth candidate (No), the command setting section 44 proceeds to a disconnection process of step S99.

### SBC Subband Setting Process

Next, the SBC subband setting process will be described.

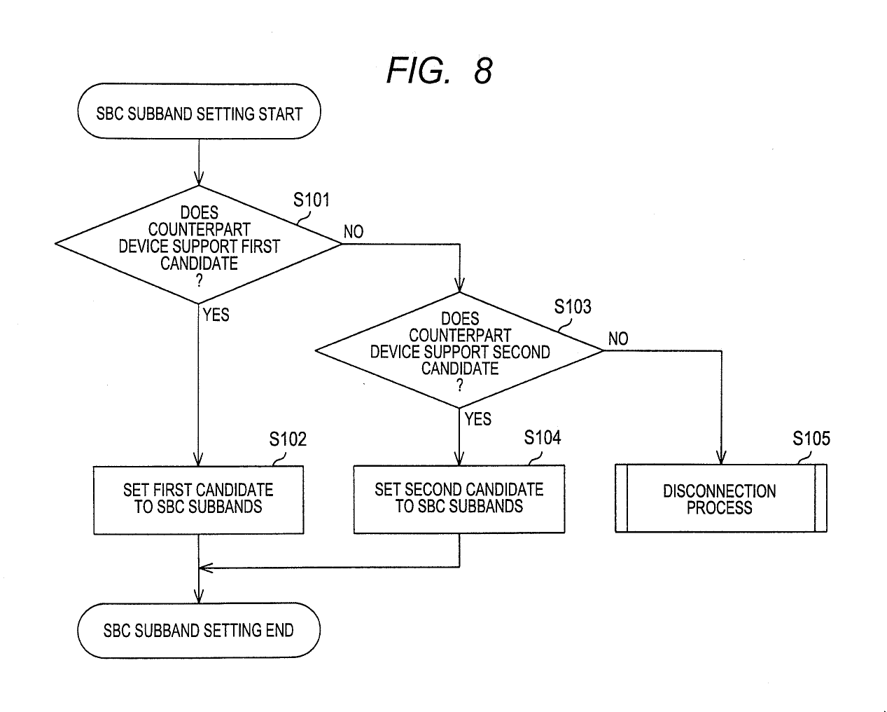

FIG. 8 is a flowchart showing a procedure example of the above-described SBC subband setting process. The difference between FIG. 5 and FIG. 8 is only that the parameter is changed from “SBC sampling frequency” to “SBC subbands”.

Step S101: The command setting section 44 compares a parameter of a first candidate (a first priority) stored in the SBC subband priority management table 52 with a value held in the parameter holding table 60 (a parameter reported from the remote device). As a result, when it has been determined that the remote device corresponds to the parameter of the first candidate (Yes), the command setting section 44 proceeds to step S102.

Step S102: In this case, the command setting section 44 sets the parameter of the first candidate (for example, “4”) to the SBC bands and terminates this sub-routine (return).

On the other hand, when the remote device does not also correspond to the parameter of the first candidate in the previous step S101 (No), the command setting section 44 executes step S103.

Step S103: Next, the command setting section 44 compares a parameter of a second candidate (a second priority) with a value held in the parameter holding table 60. As a result, when it has been determined that the remote device corresponds to the parameter of the second candidate (Yes), the command setting section 44 proceeds to step S104.

Step S104: In this case, the command setting section 44 sets the parameter of the second candidate (for example, “8”) to the SBC bands and terminates this sub-routine (return).

On the other hand, when the remote device does not also correspond to the parameter of the second candidate (No), the command setting section 44 proceeds to a disconnection process of step S105.

### SBC Allocation Method Setting Process

Next, the SBC allocation method setting process will be described.

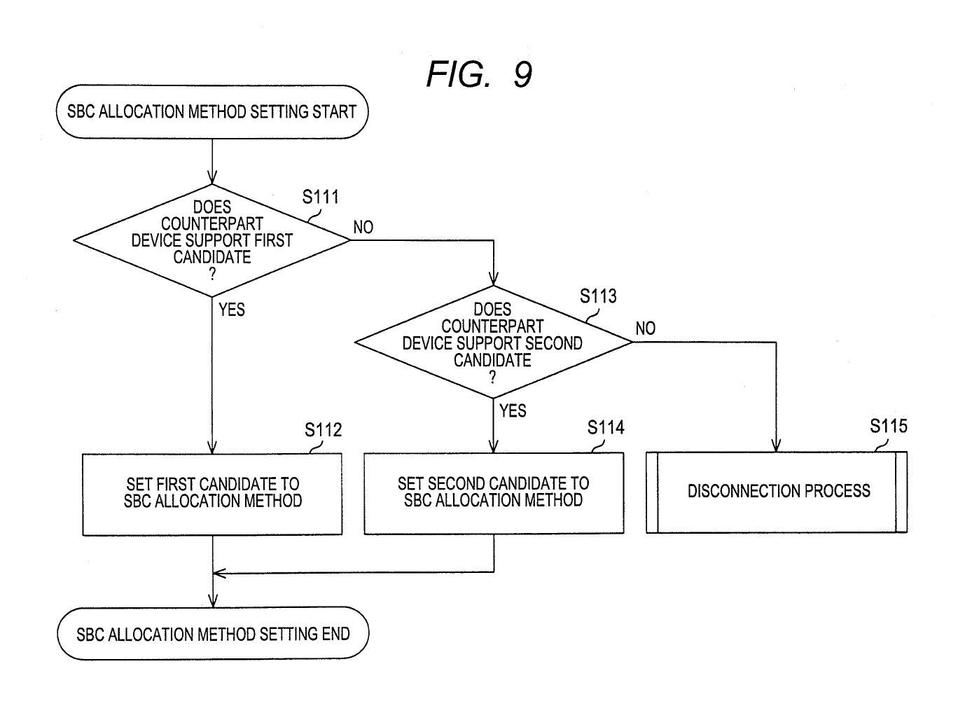

FIG. 9 is a flowchart showing a procedure example of the above-described SBC allocation method setting process. The difference between FIG. 5 and FIG. 9 is only that the parameter is changed from “SBC sampling frequency” to “SBC allocation method”.

Step S111: The command setting section 44 compares a parameter of a first candidate (a first priority) stored in the SBC allocation method priority management table 54 with a value held in the parameter holding table 60 (a parameter reported from the remote device). As a result, when it has been determined that the remote device corresponds to the parameter of the first candidate (Yes), the command setting section 44 proceeds to step S112.

Step S112: In this case, the command setting section 44 sets the parameter of the first candidate (for example, “SNR”) to the SBC allocation method and terminates this sub-routine (return).

On the other hand, when the remote device does not also correspond to the parameter of the first candidate in the previous step S111 (No), the command setting section 44 executes step S113.

Step S113: Next, the command setting section 44 compares a parameter of a second candidate (a second priority) with a value held in the parameter holding table 60. As a result, when it has been determined that the remote device corresponds to the parameter of the second candidate (Yes), the command setting section 44 proceeds to step S114.

Step S114: In this case, the command setting section 44 sets the parameter of the second candidate (for example, “Loudness”) to the SBC allocation method and terminates this sub-routine (return).

On the other hand, when the remote device does not also correspond to the parameter of the second candidate (No), the command setting section 44 proceeds to a disconnection process of step S115.

### Process of Setting SBC Minimum Bit Pool Value And SBC Maximum Bit Pool Value

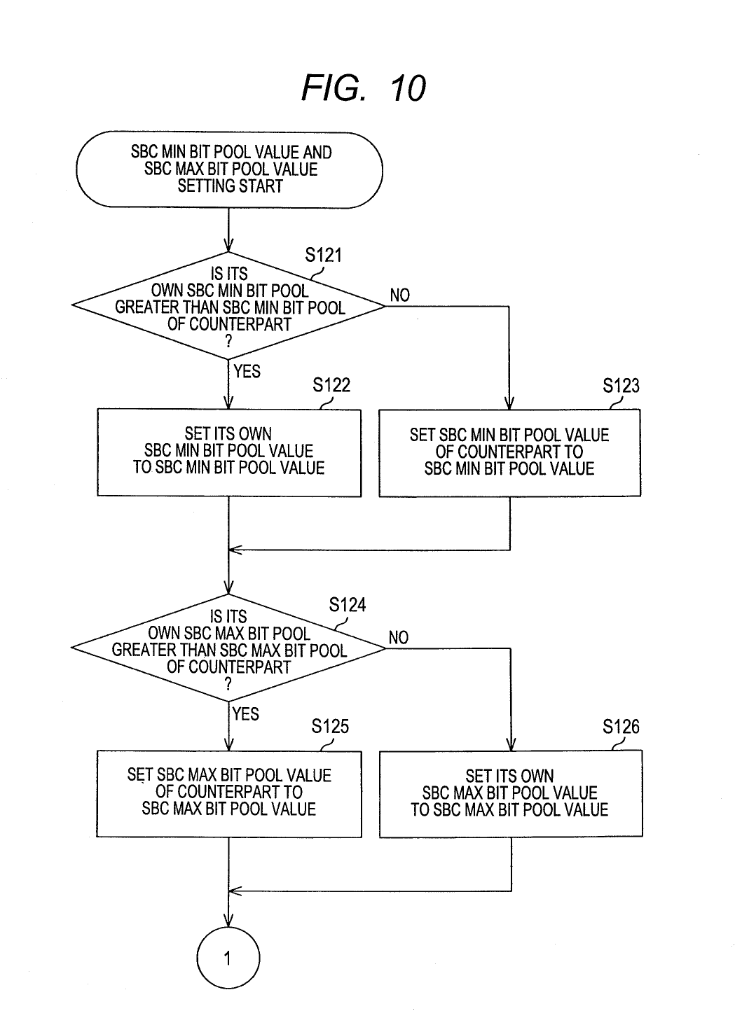

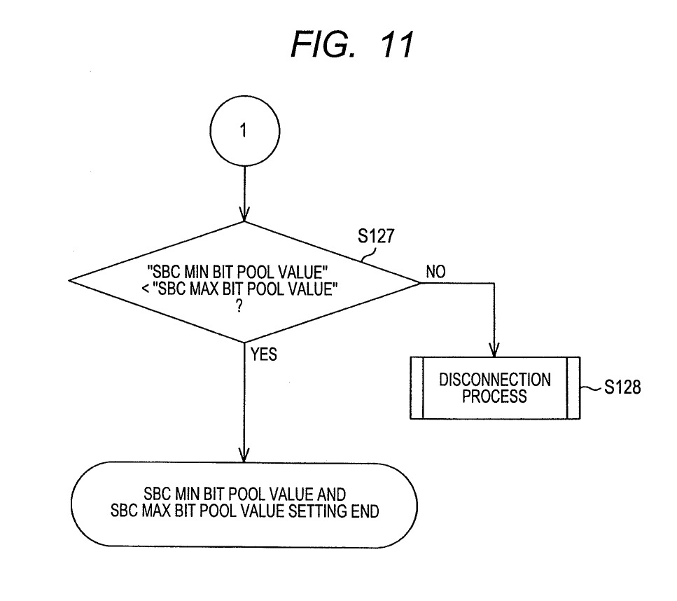

Next, FIGS. 10 and 11 are a flowchart showing a procedure example of a process of setting an SBC minimum bit pool value and an SBC maximum bit pool value. The content of the process is slightly different from those of the previous, processes.

In step S121, first, as a parameter set to the setting table 56, the command setting section 44 compares the SBC minimum bit pool value with a value held in the parameter holding table 60 (a parameter reported from the remote device). As a result, when it has been determined that the number of values of the local device (indicated by “its own” in the figure) is greater than the number of values of the remote device (indicated by “counterpart” in the figure) (Yes), the command setting section 44 proceeds to step S122.

Step S122: In this case, the command setting section 44 sets the SBC minimum bit pool value of the local device as a current parameter.

On the other hand, when the value of the local device is not greater than the value of the remote device in the previous step S121 (No), the command setting section 44 executes step S123.

Step S123: In this case, the command setting section 44 sets the SBC minimum bit pool value of the remote device as the current parameter.

Step S124: Next, as a parameter set to the setting table 56, the command setting section 44 compares the SBC maximum bit pool value with a value held in the parameter holding table 60 (a parameter reported from the remote device). As a result, when it has been made that the number of values of the local device (indicated by “its own” in the figure) is greater than the number of values of the remote device (indicated by “counterpart” in the figure) (Yes), the command setting section 44 proceeds to step S125.

Step S125: In this case, the command setting section 44 sets the SBC maximum bit pool value of the remote device as a current parameter.

On the other hand, when the value of the local device is not greater than the value of the remote device in the previous step S124 (No), the command setting section 44 executes step S126.

Step S126: In this case, the command setting section 44 sets the SBC maximum bit pool value of the local device as the current parameter (see FIG. 11: a connection symbol (1)→(1)).

Step S127: The command setting section 44 compares the currently set SBC minimum bit pool value with the SBC maximum bit pool value. As a result, when it has been determined that the SBC maximum bit pool value is greater than the SBC minimum bit pool value (Yes), the command setting section 44 terminates this sub-routine (return).

On the other hand, when the SBC maximum bit pool value is not greater than the SBC minimum bit pool value (No), the command setting section 44 proceeds to a disconnection process of step S128.

### SCMS Capability Setting Process

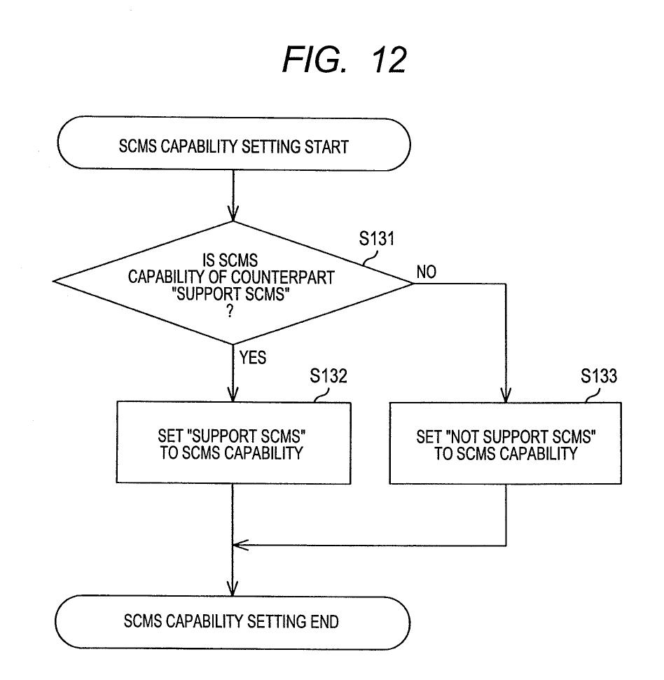

Next, FIG. 12 is a flowchart showing a procedure example of the SCMS capability setting process. The content of this process is different from those of the processes of FIGS. 5 to 10.

Step S131: Here, first, the command setting section 44 refers to a value held in the parameter holding table 60 (a parameter from the remote device). When it has been determined that a value of the remote device (indicated by “counterpart” in the figure) is “Support SCMS” (Yes), the command setting section 44 proceeds to step S132.

Step S132: In this case, the command setting section 44 sets “Support SCMS” as an SCMS capability parameter.

On the other hand, when the value of the remote device is not “Support SCMS” in the previous step S131 (No), the command setting section 44 executes step S133.

Step S133: In this case, the command setting section 44 sets “Not Support SCMS” as the SCMS capability parameter.

When the above procedure is completed, the command setting section 44 terminates this sub-routine (return). In this sub-routine, a disconnection process is not selected.

In terms of (1) SBC sampling frequency, (2) SBC channel mode, (3) SBC block length, (4) SBC subbands, (5) SBC allocation method as described above, a value reported from the remote device is compared with a priority set to the local device and a parameter matching a higher candidate can be preferentially set when possible. Thus, a connection request command can be issued from the local device by setting a higher-priority parameter among parameters supported by the remote device, so that mutual connectivity between devices can be improved and thereafter wireless communication can be smoothly performed.

### Disconnection Process

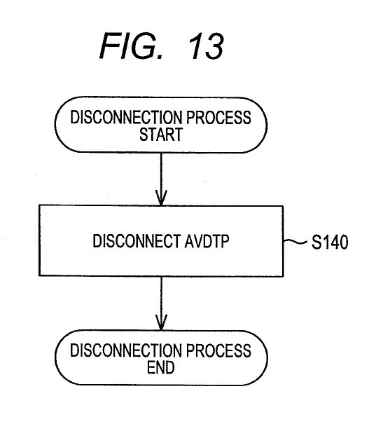

FIG. 13 is a flowchart showing the content of the disconnection process. The disconnection process shown here is common among all entities selected in FIGS. 5 to 9 and FIG. 11 described above.

Step S140: When the disconnection process has been selected, the command setting section 44 selects an AVDTP disconnection without setting a connection request command. Since a disconnection command is transmitted from the local device to the remote device, subsequent connection sequence (FIG. 3) is stopped.

When a parameter supported by the remote device ultimately does not match a parameter set to the local device, it can be made clear that a connection relationship between two devices cannot be established by terminating the above connection sequence. In this case, the user can promptly take action to select another remote device in place of a current remote device intended for connection.

The present invention is not limited to the above-described embodiment and various modifications may be made. For example, a device using a communication module of the present invention is not limited to the in-vehicle unit 12, and may be other devices. The remote device is not limited to the portable devices 14, 16, and 18.

The configuration of the BT module 30 included in the embodiments is only an example of functional block elements. The functions thereof may be all provided by resources of a microcomputer (CPU), and each function may be implemented by an application.

It should be understood by those skilled in the art that various modifications, combinations, sub-combinations and alterations may occur depending on design requirements and other factors insofar as they are within the scope of the appended claims of the equivalents thereof.

What is claimed is:

1. A communication module mounted on a local device wirelessly communicating with a remote device having a wireless communication function on the basis of a predetermined communication protocol, comprising:
a wireless communication section configured to wirelessly communicate with the remote device on the basis of the predetermined communication protocol;
a storage section configured to store a plurality of parameters defined by the predetermined communication protocol; and
a connection processing section configured to issue a connection request to the remote device using a parameter reported from the remote device as a result of inquiring of the remote device about a corresponding parameter when a connection to the remote device is made.

2. The communication module according to claim 1,
wherein the storage section stores the plurality of parameters in a state in which a priority for preferential use is pre-set when the connection to the remote device is made, and
wherein the connection processing section issues the connection request to the remote device by preferentially employing a higher-priority parameter stored in the storage section when the number of parameters reported from the remote device is equal to or greater than 2 as the result of inquiring of the remote device.

3. The communication module according to claim 1,
wherein the storage section stores a plurality of values for at least one of a sampling frequency, a channel mode, a block length, a subband, and an allocation method as the parameters.

4. The communication module according to claim 3,
wherein all the parameters use a Sub Band Codec (SBC).

5. The communication module according to claim 1,
wherein the wireless communication section communicates with the remote device on the basis of Audio/Video Distribution Transport Protocol(AVDTP).

6. A communication method for performing wireless communication based on a predetermined communication protocol between a remote device and a local device having a wireless communication function, comprising:
designating a plurality of parameters defined by the predetermined communication protocol;
inquiring about a corresponding parameter from the local device to the remote device when a connection to the local device is made;
receiving, by the local device, a response from the remote device as a notification; and
issuing a connection request to the remote device using a parameter reported from the remote device.

7. The communication method according to claim 6,
wherein the designating step includes:
designating the plurality of parameters in a state in which a priority to be preferentially used is pre-set when the connection to the remote device is made, and
wherein the issuing step includes:
issuing the connection request to the remote device by preferentially employing a higher-priority parameter set in the designating step when the number of parameters reported from the remote device is equal to or greater than 2.

8. The communication method according to claim 6,
wherein the designating step includes:
designating a plurality of values for at least one of a sampling frequency, a channel mode, a block length, a subband, and an allocation method as the parameters.

9. The communication method according to claim 8,
wherein all the parameters use a Sub Band Codec (SBC).

10. The communication method according to claim 6,
wherein communication based on Audio/Video Distribution Transport Protocol (AVDTP) is performed between the local device and the remote device.
